(19) United States
(12) Patent Application Publication
(10) Pub. No.: US 2002/0107938 A1
(43) Pub. Date: Aug. 8, 2002

(54) Method of and system for improving communication over the internet

(76) Inventors: Michael Moroney, New South Wales (AU); Matthew Quinn, New South Wales (AU)

Correspondence Address: CESARI AND MCKENNA, LLP, 88 BLACK FALCON AVENUE, BOSTON, MA, 02210, US

(21) Appl. No.: 09/762,512

(22) Filed: Feb. 7, 2001

(51) Int. Cl. G06F 15/16; G06F 17/30; G06F 7/00

(52) U.S. Cl. 709/218; 707/3

(57) ABSTRACT

The present invention relates to a new type of method of and system for improving communication over the Internet, and in a preferred embodiment, a method of providing a user with information using the Internet, whereby the method includes:

a user accessing an organization's web-site, via a user terminal, and activating an icon located on the organization's web-site;

activation of the icon resulting in the user being placed in communication with a database server;

presenting data fields to the user via the database server and allowing the user to select data fields of their choice, the user selections being communicated to the database server;

database searching software locating information, in a database associated with the database server, based on the user selected data fields communicated to the database server; and

transmitting the located information to the user;

whereby, the located information is transmitted to the user in the form of an electronic business card or the like.

### TECHNICAL FIELD

The present invention relates to a new type of method of and system for improving communication over the Internet, and in particular, to a method of and system for facilitating an improved way of obtaining further or more detailed information by a user from an organization, for example a company or business, than is presently available.

Furthermore, the present invention relates to a method of and system for facilitating an improved means of demonstrating user interest in certain goods or services to an organization, for example a company or business, than is presently available.

### BACKGROUND ART

Presently, when Internet users, hereinafter referred to as users, find an organization, for example a company or business or the like, on the Internet which they are interested in, but desire more detailed or further information from, they have two main options open to them for this further communication. Firstly, the user may fill out a request/inquiry form provided on the organization's website, or secondly, the user may send an e-mail message to the organization.

Request forms require the user to fill out their personal details and pose their question, then transmit the form. A significant problem associated with the use of request forms is that a user does not know with whom they are dealing with, yet the user has to leave their personal details in order to receive a reply. Moreover, significant delays of up to a week can be encountered by the user in receiving a reply, which can be due to the recipient organization of the request form having to sort and redirect the request form to the appropriate personnel. Furthermore, when a reply is received it usually states it is from ‘sales@’, ‘support@’ or the like, thus the user still does not know with whom they are dealing and whether the reply is from the most appropriate person

Generalised company e-mail addresses, such as info@ and support@, allow a user to send an e-mail message containing their question to a group or department within the organization and then wait for a reply. Similar to request forms, the user docs not know with whom they are dealing when they send the e-mail and the e-mail often has to be redirected internally within the organization.

A problem with these communication pathways, is that users do not obtain personalised, that is person to person, contact with organizations, for example companies, thus, the user does not know if they are obtaining an answer from the appropriate person within the organization whom should be providing the answer.

In addition, there are presently limitations in the extent to which an organization can obtain correlated marketing information from users via the organization's Internet web-site. A need exists to provide a means for the efficient categorisation or filtering of user emails so that user interest in certain goods or services may be more readily obtained by the organization.

This identifies a need for an improved type of method of and system for communication over the Internet which overcomes the problems inherent in the prior art.

This also identifies a need for an improved method of and system for facilitating an improved means of demonstrating user interest in certain goods or services to an organization, such as a company.

It should be noted that reference to the term organization should be taken to mean a reference to any form of company, business entity, firm, government department, charity, or other organized body.

### DISCLOSURE OF INVENTION

The present invention seeks to provide a method of and system for facilitating an improved means of obtaining further or more detailed information about an organization, the organization's personnel, and/or the organization's goods or services, by a user from a database which is linked to a database provider's web-site.

The present invention further seeks to provide a method of and system for facilitating an improved means of demonstrating user interest in certain goods or services to an organization.

Accordingly, the present invention seeks to provide a more direct and personal communication pathway between users and an organization when the user requires more detailed or further information than is readily accessible on the organization's web-site.

The present invention according to one aspect seeks to provide a method of providing a user with information using the Internet, whereby the method includes:

a user accessing an organization's web-site, via a user terminal, and activating an icon located on the organization's web-site;

activation of the icon resulting in the user being placed in communication with a database server;

presenting data fields to the user via the database server and allowing the user to select data fields of their choice, the user selections being communicated to the database server;

database searching software locating information, in a database associated with the database server, based on the user selected data fields communicated to the database server; and

transmitting the located information to the user;

whereby, the located information is transmitted to the user in the form of an electronic business card or the like.

In a further broad form of the present invention, all communications to and from the user occur using the Internet.

The present invention according to another aspect seeks to provide that the user is provided with means to transmit user selected data fields relating to user personal information to the organization.

Preferably, the database contains more detailed data relating to the organization than is presented to a user on the organization's web-site.

Preferably, the database contains more data relating to the organization that is more readily accessible to a user than the data available on the organization's web-site.

Also preferably, the information transmitted to the user is at least one electronic business card of an owner, employee, consultant or other person associated with the organization.

Also preferably, the electronic business card is compatible with standard computerised address books and may be copied to standard computerised address books, Personal Digital Assistants (PDAs), or mobile phones.

In a specific embodiment, the information on the database pertains to the organization's personnel contact information,

In a further specific embodiment, the database stores information relating to users who have activated the icon on the organization's web-site.

In still a further specific embodiment, advertising may be attached to the information presented to the user.

In a broad form, the selectable data fields include at least one option directed to departments, products, goods, services, personnel, geographic location or the like.

In a further embodiment of the present invention, the information transmitted to the user is via e-mail, Short Message Service (SMS), or Wireless Application Protocol (WAP). In a broad form of the present invention, the user terminal is a computer, PC, notebook, laptop, handheld, PDA, mobile phone, or similar electronic device.

In a preferred form of the present invention, a new organization may be electronically stored in the database by the new organization completing and electronically transmitting a registration form or the like to the database provider.

In a further preferred form, advertising attachments to the information transmitted to the user are paid for in a separate subscription cost.

According to another aspect of the present invention, personal particulars of a user including their name, e-mail address, location and the like are stored in the database.

In a particular form of the present invention, the particulars of a user or group of users can be transmitted electronically to an organization, or any of the other organizations in the database.

According to another aspect, the information on the database is linked to more than one web-site.

In a specific embodiment, the particulars of a user transmitted to the organization is presented to the organization in the form of an electronic business card or the like.

In accordance with a further embodiment of the present invention there is provided a method of providing a user with information in relation to goods or services offered by various organizations, the information being communicated to the user using the Internet, whereby the method includes:

a database provider maintaining a database;

organizations electronically indicating interest in receiving sales leads to the database provider and information relating to the organization thereafter being recorded in the database;

a user electronically transmitting a request, via a user terminal, to the database provider relating to goods or services for which they have an interest in receiving further details and special offers on, via the Internet;

information filtering software categorising the user request;

if the categorised user request relates to an organization's goods or services the user is sent at least one electronic business card or the like from the database provider on behalf of the organization.

In accordance with a further embodiment of the present invention there is provided a system of providing a user with information, the information in relation to an organization, using the Internet, whereby the system includes:

an organization's web-site provided with an icon;

a user terminal, the user terminal providing means for a user to connect to the organization's web-site;

a database;

means to allow the user to activate the icon located on the organization's web-site, the user being placed in communication with a database server, associated with the database, after activation of the icon;

means to present data fields to the user and allow the user to select data fields of their choice;

database searching software to locate information within the database based on the user selected data fields; and

means to transmit the information to the user in the form of at least one electronic business card or the like.

In accordance with a still further embodiment of the present invention there is provided a system of providing a user with information in relation to goods or services offered by various organizations, the information being communicated to the user using the Internet, whereby the system includes the components:

a database provider which maintains a database;

means for an organization to electronically indicate their interest in receiving sales leads to the database provider and information relating to the organization thereafter being recorded in the database;

a user terminal to facilitate a user electronically transmitting a request to the database provider, the request relating to goods or services for which the user has an interest in receiving further details and special offers on;

information filtering software for categorising the user request; whereby, if the categorised user request relates to the organization's goods or services the user is sent at least one electronic business card or the like from the database provider on behalf of the organization.

In another preferred form of the invention there is provided a method of providing a user with information using the Internet, substantially according to the embodiment described in the specification with reference to the accompanying figures.

In another preferred form of the invention there is provided a system for providing a user with information using the Internet, substantially according to the embodiment described in the specification with reference to the accompanying figures.

### BRIEF DESCRIPTION OF FIGURES

The present invention will become better understood from the following detailed description of a preferred but non-limiting embodiment thereof, described in connection with the accompanying figures, wherein:

FIG. 1 illustrates a preferred embodiment of the present invention wherein, the figure shows a flow chart of the preferred embodiment.

FIG. 2 illustrates a preferred embodiment of the present invention wherein, the figure shows a flow chart indicating the registration component.

FIG. 3 illustrates a preferred embodiment of the present invention wherein, the figure shows a flow chart detailing the data retrieval phase.

FIG. 4 illustrates a preferred embodiment of the present invention wherein, the figure shows a flow chart detailing an advertising component.

FIG. 5 illustrates a preferred embodiment of the present invention wherein, the figure shows a flow chart detailing how e-mail filtering may occur.

### MODES FOR CARRYING OUT THE INVENTION

The present invention provides an improved method of and system for improving communication over the Internet. In the figures, incorporated to illustrate the features of the present invention, like reference numerals are used to identify like parts throughout the figures.

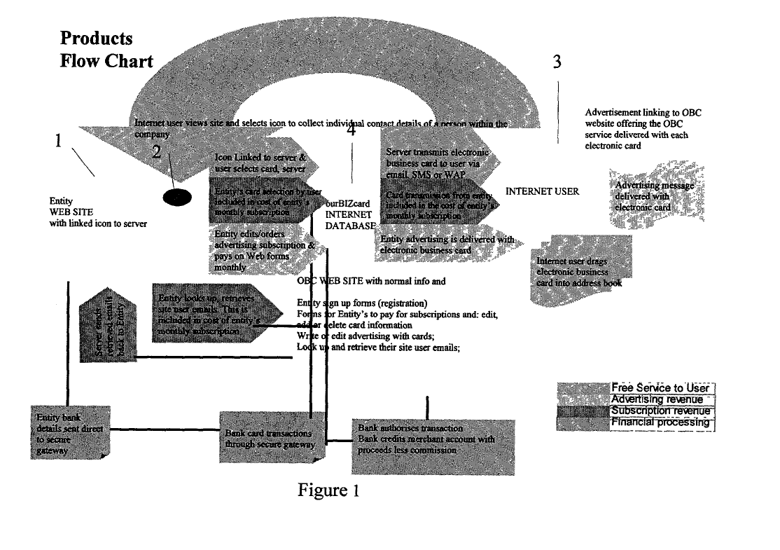

A preferred, but non-limiting, embodiment of the present invention is shown in FIG. 1. An organization's web site 1 is provided with an icon 2 which resides on the organization's web-site and is a small addition, essentially a hyperlink to the URL of an Internet database server only.

An Internet user 3 may activate the icon 2 which acts as a link to a database 4. The user's details, for example the user's e-mail address, is stored in the database 4 upon the user 3 being placed in communication with the database server, or upon a request being made to the user. The user 3 is presented with selectable data fields, the data thereof residing on the database 4.

Selectable data fields may be comprised of information pertaining to the personnel within the organization, for example employees of a company. The user 3 may select data fields which may include the type of products or goods, the type of service/s, department, geographical location, type of question, or any other type of data field which may be embodied in a searchable database.

After a user has selected the relevant data fields, software is provided to retrieve the relevant information or data from the database, in the present preferred embodiment the relevant information is in the form of an electronic business card or the like. After retrieving the electronic business card, or retrieving the relevant information or data and constructing an electronic business card, the electronic business card is transmitted to the user 3 via e-mail, SMS or WAP.

The user 3 may then copy the electronic business card to their personal computerised address book. Hence, the user is placed in contact with the relevant person from the organization, for example a company or business, to which the user's selected data fields pertain.

Furthermore, when selecting data fields the user may be provided with the opportunity and ability to transmit their own data fields relating to their own personal information to the organisation.

The method of and system for the present invention thus allows a user 3 to choose where and from whom they obtain the further information they require. This provides the user 3 with knowledge of whom they are dealing with when they proceed to contact the company.

Only the addition of a hyperlink is required to be placed on an organization's web-site 2, thus not interfering with the web-site's general operation. The electronic business card received by a user 3 may be automatically placed in the user's personal private database or computerised address book by providing the electronic business card with a software button which when depressed causes the information in the electronic business card to be automatically entered into the user's address book. Alternatively, the user 3 may drag-and-drop or cut-and-paste the information. It should be noted that an electronic business card/s may be linked to multiple web-site's.

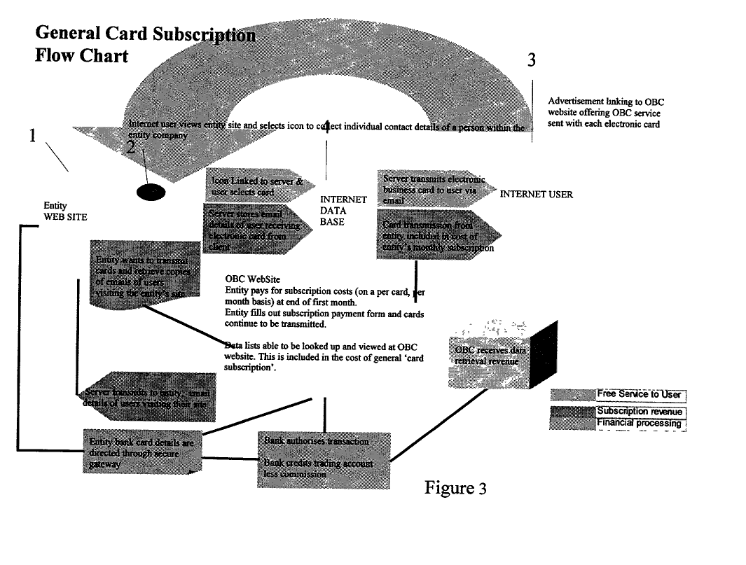

An organization may also request that advertising be attached to electronic business cards sent to users, as is detailed in FIG. 3. When a user 3 requests an electronic business card from an organization, advertising associated with the organization, or indeed any other organization, may be attached to the electronic business card which is sent to the user 3. Advertising attachments to electronic business cards preferably attract a separate subscription fee (for example per card, per month), payment for such a service may, for example, be conducted electronically over the Internet as shown in the figure. However, it should be noted that many variations are possible in payment methods, indeed, having reference to all the accompanying figures, the payment schemes presented are illustrative only and may be significantly varied.

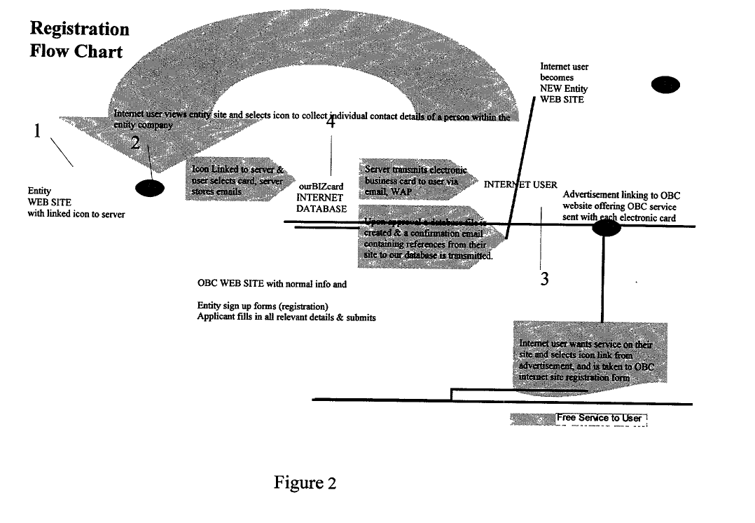

In a further embodiment of the present invention a web-site is provided associated with the database 4 wherein an new organization may register to have the icon 2 placed on its web-site as is illustrated in FIG. 2. Furthermore, the database web-site may provide for editing of the advertising attachments associated with electronic business cards, In addition, an organization may be provided with access to be able to look-up and retrieve the e-mail addresses of users who have accessed their web-site.

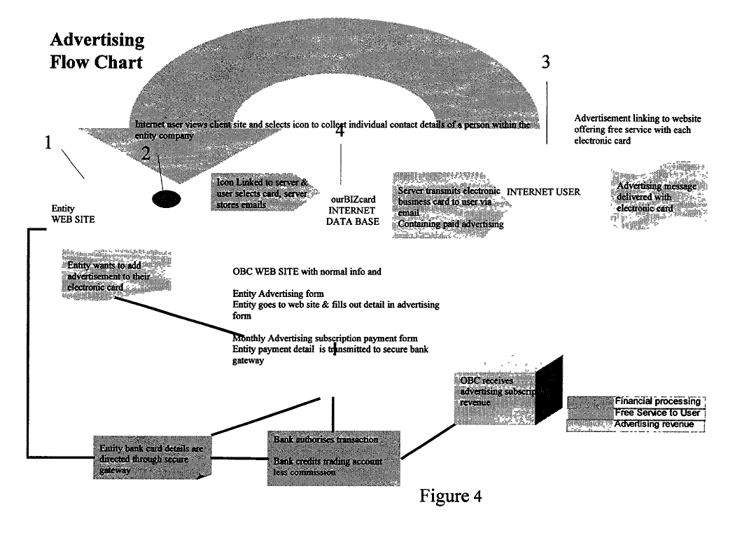

Preferably, retrieval of e-mail addresses from the database 4 will be included in general subscription costs from an organization, as is illustrated in FIG. 4.

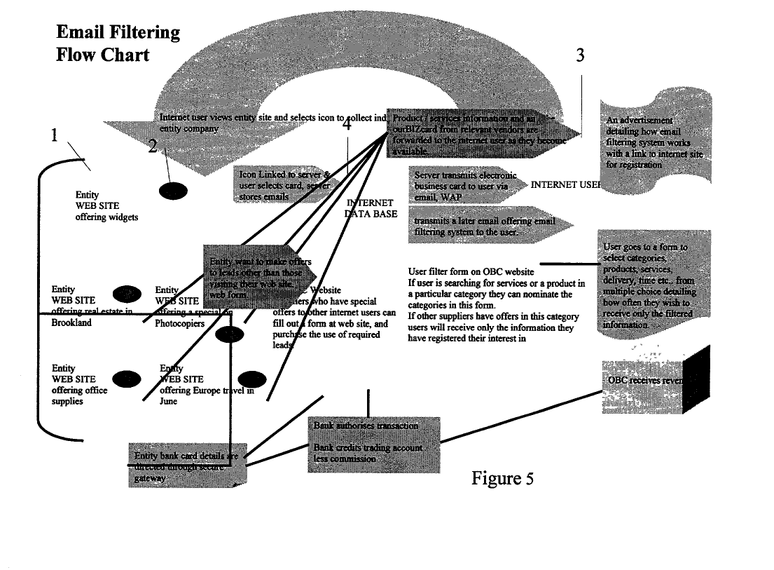

In a further preferred form of the present invention, as is presented FIG. 5, a user 3 may register their interest in receiving information for goods or services in a particular category, Organization's who have special offers or deals may fill out an electronic form via the web-site associated with the database 4 indicating what they are offering.

Filtering software then attempts to match user's interests with organization's offers, if the software matching algorithm finds a correlation between goods or services from the organization and a users interests then the relevant information may be forwarded to the user 3.

In an alternate embodiment, a user's details may be forwarded to the relevant organization thereby leaving the organization to contact the user themselves.

Preferably, provision of these sales leads for users interested in an organization's goods or services attracts a fee from the organization, that is, organization's can purchase the use of sales leads, though the database provider, in various categories.

Thus, there has been provided in accordance with the present invention, a method of and system for facilitating an improved way of obtaining further or more detailed information by a user from an organization which satisfies the advantages set forth above.

Although the preferred embodiment has been described in detail, it should be understood that various changes, substitutions, and alterations can be made herein by one of ordinary skill in the art without departing from the spirit or scope of the present invention as hereinbefore described and as hereinafter claimed.

The claims defining the invention are as follows:

1. A method of providing a user with information using the Internet, whereby the method includes:
a user accessing an organization's web-site, via a user terminal, and activating an icon located on the organization's web-site;
activation of the icon resulting in the user being placed in communication with a database server;
presenting data fields to the user via the database server and allowing the user to select data fields of their choice, the user selections being communicated to the database server;
database searching software locating information, in a database associated with the database server, based on the user selected data fields communicated to the database server; and
transmitting the located information to the user;
whereby, the located information is transmitted to the user in the form of an electronic business card or the like.

2. The method as claimed in claim 1 wherein, all communications to and from the user occur using the Internet.

3. The method as claimed in claim 1 wherein, the user is provided with means to transmit user selected data fields relating to user personal information to the organization.

4. The method as claimed in claim 1 wherein, the database contains more readily accessible data relating to the organization than is presented to a user on the organization's web-site.

5. The method as claimed in claim 1 wherein, the information transmitted to the user is at least one electronic business card of an owner, employee, consultant or other person associated with the organization.

6. The method as claimed in claim 5 wherein, the electronic business card is compatible with standard computerised address books and may be copied to standard computerised address books, Personal Digital Assistants (PDAs), or mobile phones.

7. The method as claimed in claim 1 wherein, the information on the database pertains to the organization's personnel contact information.

8. The method as claimed in claim 1 wherein, the database stores information relating to users who have activated the icon on the organization's web-site.

9. The method as claimed claim 1 wherein, advertising may be attached to the information presented to the user.

10. The method as claimed claim 1 wherein, the selectable data fields include at least one option directed to departments, products, goods, services, personnel, geographic location or the like.

11. The method as claimed in claim 1 wherein, the information transmitted to the user is via e-mail, Short Message Service (SMS), or Wireless Application Protocol (WAP).

12. The method as claimed in claim 1 wherein, the user terminal is a computer, PC, notebook, laptop, handheld, PDA, mobile phone, or similar electronic device.

13. The method as claimed in claim 1 wherein, a new organization may be electronically stored in the database by the new organization completing and electronically transmitting a registration form or the like to a database provider.

14. The method as claimed in claim 1 wherein, advertising attachments to the information transmitted to the user are paid for in a separate subscription cost.

15. The method as claimed in claim 1 wherein, personal particulars of a user including their name, e-mail address, location and the like are stored in the database.

16. The method as claimed in claim 15 wherein, the particulars of a user or group of users are transmitted electronically to the organization, or any of the other organizations in the database.

17. The method as claimed in claim 1 wherein, the information on the database is linked to more than one web-site.

18. The method as claimed claim 16 wherein, the particulars of a user transmitted to the organization is presented to the organization in the form of an electronic business card or the like.

19. A method of providing a user with information in relation to goods or services offered by various organizations, the information being communicated to the user using the Internet, whereby the method includes:
a database provider maintaining a database;
organizations electronically indicating interest in receiving sales leads to the database provider and information relating to the organization thereafter being recorded in the database;
a user electronically transmitting a request, via a user terminal, to the database provider relating to goods or services for which they have an interest in receiving further details and special offers on, via the Internet;
information filtering software categorising the user request;
if the categorised user request relates to an organization's goods or services the user is sent at least one electronic business card or the like from the database provider on behalf of the organization.

20. The method as claimed in claim 19 wherein, the database provider can provide the organization with marketing information relating to user requests.

21. The method as claimed in claim 19 wherein, particulars of a user including name, e-mail address, location and the like are stored in the database.

22. The method as claimed in claim 19 wherein, the user request is transmitted via the Internet, e-mail, SMS, WAP or other electronic means.

23. The method as claimed in claim 19 wherein, a fee is charged to the organization for transmitting an electronic business card to users.

24. A system of providing a user with information, the information in relation to an organization, using the Internet, whereby the system includes:
an organization's web-site provided with an icon;
a user terminal, the user terminal providing means for a user to connect to the organization's web-site;
a database;
means to allow the user to activate the icon located on the organization's web-site, the user being placed in communication with a database server, associated with the database, after activation of the icon;
means to present data fields to the user and allow the user to select data fields of their choice;
database searching software to locate information within the database based on the user selected data fields; and
means to transmit the information to the user in the form of at least one electronic business card or the like.

25. The system as claimed in claim 24 wherein, all communications to and from the user occur using the Internet.

26. The system as claimed in claim 24 wherein, the user is provided with means to transmit user selected data fields relating to user personal information to the organization.

27. The system as claimed in claim 24 wherein, the information transmitted to the user is at least one electronic business card of an owner, employee, consultant or other person associated with the organization.

28. The system as claimed in claim 24 wherein, the electronic business card is compatible with standard computerised address books and may be copied to standard computerised address books, Personal Digital Assistants (PDAs), or mobile phones.

29. The system as claimed in claim 24 wherein, the database stores information relating to users who have activated the icon on the organization's web-site.

30. The system as claimed in claim 24 wherein, advertising may be attached to the electronic business card presented to the user.

31. The system as claimed in claim 24 wherein, the selectable data fields include at least one option directed to departments, products, goods, services, personnel, geographic location or the like.

32. The system as claimed in claim 24 wherein, the information transmitted to the user is via e-mail, Short Message Service (SMS), or Wireless Application Protocol (WAP).

33. The system as claimed in claim 24 wherein, the user terminal is a computer, PC, notebook, laptop, handheld, PDA, mobile phone, or similar electronic device.

34. A system of providing a user with information in relation to goods or services offered by various organizations, the information being communicated to the user using the Internet, whereby the system includes the components:
a database provider which maintains a database;
means for an organization to electronically indicate their interest in receiving sales leads to the database provider and information relating to the organization thereafter being recorded in the database;
a user terminal to facilitate a user electronically transmitting a request to the database provider, the request relating to goods or services for which the user has an interest in receiving further details and special offers on;
information filtering software for categorising the user request;
whereby, if the categorised user request relates to the organization's goods or services the user is sent at least one electronic business card or the like from the database provider on behalf of the organization.

35. The system as claimed in claim 34 wherein, the database provider can provide the organization with marketing information relating to user requests.

36. The system as claimed in claim 34 wherein, the user request is transmitted via the Internet, e-mail, SMS, WAP or other electronic means.
